(19) United States
(12) Patent Application Publication
(10) Pub. No.: US 2024/0118068 A1
(43) Pub. Date: Apr. 11, 2024

(54) SYSTEMS AND METHODS FOR ROBUST DISTANCE MEASUREMENT

(71) Applicant: WasteWizer Inc., Roanoke, VA (US)

(72) Inventors: Thomas Lee SPENCER, Atlanta, GA (US); Patrick DOYLE, Marietta, GA (US); Jay Robert BRENNER, Atlanta, GA (US)

(21) Appl. No.: 18/390,649

(22) Filed: Dec. 20, 2023

Related U.S. Application Data
(63) Continuation of application No. PCT/IB2022/055840, filed on Jun. 23, 2022.
(60) Provisional application No. 63/202,751, filed on Jun. 23, 2021.

(51) Int. Cl. G01B 5/14; G01B 3/00

(52) U.S. Cl. CPC G01B 5/14; G01B 3/008; G01G 3/12

(57) ABSTRACT

Provided herein are various embodiments of an improved device for accurate measurement along a desired axis that is tolerant to off axis movement and other environmental factors. The measurement relies on a conversion from linear displacement of a tensile element in a pulley system which is monitored by a low power rotational encoder. The orientation and mechanical architecture of the device is set to reduce the impact of off-axis movement or forces on the measurement of interest. A computing unit determines the distance measurement by determining the state of rotation in the system in the context of the system's specific design, without the need to constantly monitor the sensor.

### RELATED APPLICATION

This application claims the benefit of priority to U.S. Provisional Application No. 63/202,571 on filed Jun. 23, 2021, which is hereby incorporated by reference herein in its entirety.

It is intended that the above-referenced application may be applicable to the concepts and embodiments disclosed herein, even if such concepts and embodiments are disclosed in the referenced applications with different limitations and configurations and described using different examples and terminology.

### FIELD OF INVENTION

The present invention relates to systems and methods for measuring height and/or distance.

### BACKGROUND OF THE INVENTION

Determining a distance, height, separation, or compression measurement is critical in many fields from construction to scientific discovery to engineering and medical practices. There are many established methods for obtaining a linear measurement of height and/or distance, such as:
Calipers (Westenberg, 1980).
Linear potentiometers (Bleeke, 1983).
Laser distance measurement arrays (Binder, 2019).
Ultrasonic distance techniques (Hueber, 2000).
Time of flight sensors (Meinherz 2017).
Optical distance measurement (Schrey, 2016).
Direct measurement via tape measure (Ricalde, 2002).

However, conventional methods for height and/or distance suffer from several drawbacks, including but not limited to the following:
In a monitored device such as for Internet of Things applications, the sensing assembly must be standalone and electronically connected. Thus, direct methods such as manual measurements using analog calipers or standard tape measures may not be useful.
When the desired measurement is along a single axis, lateral shifts may negatively affect the measurement, resulting in incorrect readings. Additionally, off-axis forces can cause damage to or even break the measurement device. Off-axis movement/loads cannot be handled by the established methods listed above due to the following:
   Fixed path measurement devices such as digital calipers and linear potentiometers do not withstand off-axis forces.
   Indirect measuring devices such as laser, ultrasonic, time-of-flight, and optical transducers require a direct line of sight between the emitting and sensing portion. Misalignment or re-trajection may increase the flight distance or cause the emitted property to miss the sensing surface altogether.
Many established methods require a high power or processing cost which is not feasible for use in Internet of Things devices or other similar low-energy budget applications.
Many established methods suffer from longevity issues due to water, dust, temperature effects, etc. in harsh environments.

Thus, there is a need for improved systems of accurately measuring a height and/or distance in real-world environments that are robust to off-axis movement and other environmental factors and that can operate electrically on low power.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

One example embodiment of a distance measurement device as provided herein may comprise an upper housing rigidly affixed to a first surface and a lower housing rigidly affixed to a second surface that is spaced apart from the first surface by a distance to be measured along an axis of interest. The device may further comprise a flexible membrane movably connecting the upper housing to the lower housing. The device may further comprise a pulley system disposed within the upper and lower housings and having a tensile element passing therethrough. The pulley system may be configured to adjust an active length of the tensile element corresponding to the distance to be measured while minimizing the impact of movement of the first and second surfaces along a direction other than the axis of interest. The device may further comprise one or more sensors that detect rotation of one or more pulleys within the pulley system, wherein the rotation corresponds to a change in the active length of the tensile element.

In some embodiments, the pulley system comprises first and second idler pulleys disposed within the upper housing and a third idler pulley disposed within the lower housing. In some embodiments, the pulley system comprises at least four idler pulleys. In still further embodiments, the device is configured to measure an additional distance along an axis that is different from the axis of interest.

In some embodiments, the pulley system is configured to maintain the tensile element taut, such that the tensile element is effective to resist movement of the first and second surfaces along a direction other than the axis of interest.

In some embodiments, the pulley system further comprises a driver pulley around which a first end of the tensile element is wound and a spring idler pulley having a spring that acts on the driver pulley to ensure that the tensile element remains taut throughout the pulley system. The rotation of the driver pulley and the spring idler pulley may correspond to a change in the active length of the tensile element. In some embodiments, the spring is a constant force spring. In some embodiments, a first magnet is attached to the driver pulley and a second magnet is attached to the spring idler pulley. The one or more sensors may be configured to detect rotation of the driver pulley and the spring idler pulley, respectively, based on movement of the first and second magnets. In some embodiments, the driver pulley has a different diameter than the spring idler pulley.

In some embodiments, the pulley system mechanically amplifies the active length of the tensile element to increase an accuracy of the distance measurement. In still further embodiments, the mechanical amplification of the active length of the tensile element is equivalent to 2× the distance to be measured.

In some embodiments, the device further includes a computing unit that converts one or more rotation measurements of the one or more sensors into a linear distance measurement corresponding to the distance to be measured. In still further embodiments, the computing unit may convert the linear distance measurement into a weight measurement.

In some embodiments, the device further comprises at least one of a temperature sensor and a humidity sensor.

One example embodiment of a method for measuring a distance as provided herein may comprise attaching an upper housing to a first surface, wherein the first surface is rigidly connected to a container. The method may further comprise attaching a lower housing to a second surface. The method may further comprise effecting a change in a distance between the first and second surfaces and causing a pulley system disposed within the upper and lower housings to displace an active length of a tensile element that corresponds to the change the distance between the first and second surfaces along an axis of interest.

In some embodiments, effecting the change in the distance comprises placing items in the container. In still further embodiments, the method comprises measuring a weight of the items that are placed in the container based on a distance measurement of the distance between the first and second surfaces.

In some embodiments, the method further comprises inputting fixed system variables to assist with a calculation of the distance between the first and second surfaces.

In some embodiments, the pulley system is configured to adjust the active length of the tensile element corresponding to the distance between the first and second surfaces while resisting any movement of the first and second surfaces along a direction other than the axis of interest.

In some embodiments, the pulley system comprises first and second idler pulleys disposed within the upper housing and a third idler pulley disposed within the lower housing. In some embodiments, the pulley system comprises at least four idler pulleys. In still further embodiments, the method may further comprise measuring an additional distance along an axis that is different from the axis of interest.

In some embodiments, the pulley system is configured to maintain the tensile element taut, such that the tensile element is effective to resist movement of the first and second surfaces along a direction other than the axis of interest.

In some embodiments, the pulley system further comprises a driver pulley around which a first end of the tensile element is wound and a spring idler pulley having a spring that acts on the driver pulley to ensure that the tensile element remains taut throughout the pulley system. The rotation of the driver pulley and the spring idler pulley may correspond to a change in the active length of the tensile element. In some embodiments, the spring is a constant force spring. In some embodiments, a first magnet is attached to the driver pulley and a second magnet is attached to the spring idler pulley. The one or more sensors may be configured to detect rotation of the driver pulley and the spring idler pulley, respectively, based on movement Of the first and second magnets. In some embodiments, the driver pulley has a different diameter than the spring idler pulley.

In some embodiments, the pulley system mechanically amplifies the active length of the tensile element to increase an accuracy of the distance measurement. In still further embodiments, the mechanical amplification of the active length of the tensile element is equivalent to 2× the distance to be measured.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 is a perspective view of one embodiment of a distance measurement system;

FIG. 2 is a perspective schematic view of the distance measurement system of FIG. 1, taken from the side;

FIG. 3 is a cross-sectional, schematic view of the distance measurement system of FIG. 1, taken from the front;

FIG. 4 is a cross-sectional view of one embodiment of a pulley of the distance measurement system of FIG. 1;

FIG. 5 is a schematic view of an alternative embodiment of a pulley system;

FIG. 6 is a flowchart illustrating an example method of calculating a distance measurement using the system of FIG. 1;

FIG. 7 is a perspective view of a potential industrial use of the distance measurement system of FIG. 1; and

FIG. 8 is a flowchart illustrating an example method of using the distance measurement system of FIG. 1.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features that may be useful in a variety of contexts, such as any field with engineering or scientific presence, including but not limited to waste, scrap, agricultural, medical, transportation, construction, and other applicable industries. However, while many aspects and features relate to, and are described in, the context of distance and/or height measurement in real-world contexts, embodiments of the present disclosure are not limited to use only in this context. For example, measurement systems as disclosed herein may provide more accurate and low-power solutions in controlled, laboratory conditions.

### Apparatus Overview

This overview is provided to introduce a selection of concepts in a simplified form that are further described below. This overview is not intended to identify key features or essential features of the claimed subject matter. Nor is this overview intended to be used to limit the claimed subject matter's scope.

Provided herein are various embodiments of distance measurement devices that can function accurately in real-world environments, accounting for factors such as environmental wear, off-axis movement, and energy considerations. According to one aspect, this disclosure describes a novel distance measuring device generally consisting of one or more idler pulleys with known dimensions and orientations, at least one wire around the pulley(s) through which tension is held throughout the measuring duration, at least one driving pulley around which the wire is wound, a constant force spring to exert a constant torque on the driving pulley and the wire, a spring idler pulley on which the constant force spring spools during operation, at least one rotational encoder to measure the rotation of the driving pulley and the spring idler pulley, a computing unit to communicate with the encoder and provide additional processing and/or interaction with the cloud, and deformable housing which encompasses the moving components to provide structural support and protection against the environment. The device can handle off-axis movement while still being able to accurately measure along the axis of interest. The device may be affixed to two plates which move linearly up and down where the degree of up and down movement is of interest to measure. Distance measurement devices as provided herein may be capable of obtaining an accurate distance measurement when the device is affixed to two plates that are able to move generally perpendicularly to the axis of interest by as much as 20% of the axial movement amount.

Details with regards to each component is provided below. Although components are disclosed with specific functionality, it should be understood that functionality may be shared between components, with some functions split between components, while other functions duplicated by the components. Furthermore, the name of the component should not be construed as limiting upon the functionality of the component.

### Apparatus Configuration

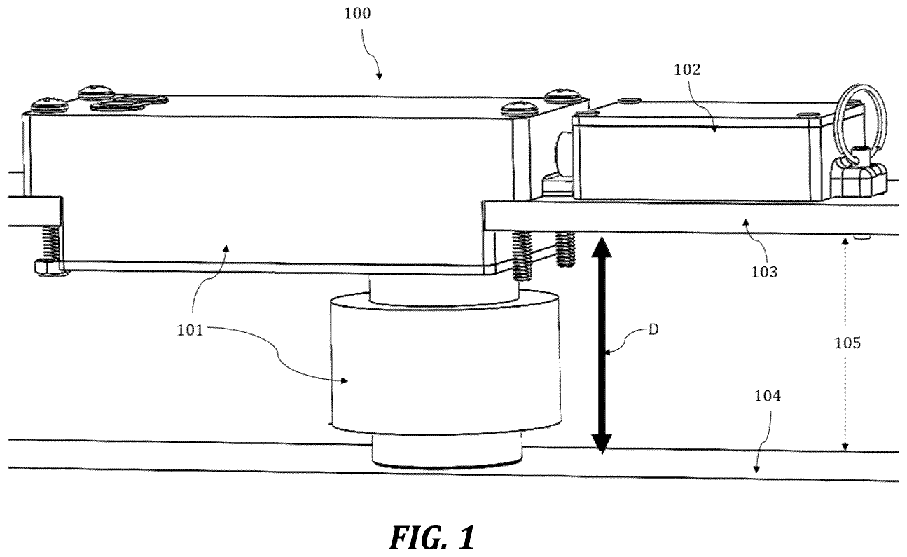

FIG. 1 illustrates an example system 100 for measuring a linear height and/or distance. The system 100 may include a linear distance measurement device 101, a battery pack 102, a top plate 103, and a bottom plate 104. In the illustrated embodiment, the measurement device 101 is rigidly affixed to both the top plate 103 and the bottom plate 104. In some embodiments, the measurement device 101 is configured for removable attachment to one or both of the plates 103, 104, via, e.g., screws, bolts, rivets, or the like. In other embodiments, the measurement device 101 is permanently affixed to one or both the plates 103, 104, via, e.g., welding, adhesive, or the like. Thus affixed to the plates 103 and 104, the linear distance measurement device 101 may be capable of measuring a distance D between a bottom surface of the top plate 103 and a top surface of the bottom plate 104 along an axis of interest 105. The measurement device 101 may be configured to accurately measure the distance D even in the event of forces and/or displacement along the axis 105 which is of interest, along with shear, stress, or torsional forces of movement.

The battery pack 102 may be configured to power electronic components of the system 100, which are discussed in more detail below. In particular, the battery pack may be rigidly affixed to the measurement device 101 to provide power to electronic components therein. In the illustrated embodiment, the battery pack 102 is affixed to the upper housing 201 and to the top plate 103, although it will be appreciated that the battery pack 102 may only be affixed to the measurement device 101 and/or may be affixed to the measurement device 101 and the bottom plate 104. In some embodiments, the battery pack 102 may be removably attached to the device 101 and/or to the plates 103, 104, to allow for replacement, removal, and/or re-charging of batteries housed therein.

Operative components of the measurement device 101 may all be securely housed within one or more protective housings to protect the components from environmental factors such as wind, rain, moisture, salinity, or the like. In particular, the measurement device 101 may comprise an upper housing 201 and a lower housing 202 that are movably connected to one another. In the illustrated embodiment, the upper housing 201 is connected to the lower housing 202 via a flexible membrane 203, e.g., a bellows, a bladder, or the like. The flexible membrane 203 may be compressible and/or extendable in the axis of interest 105. In some embodiments, the flexible membrane 203 may be capable of deforming when under shear loading. The combination of the two rigid housing components 201, 202 in conjunction with the flexible membrane 203 may help to ensure that components internal to the device 101 are kept sealed off from the outside and therefore enable the device 101 to be utilized in harsh environments.

The measurement device 101 may be capable of accurately assessing the distance D between the top plate 103 and the bottom plate 104 via a system of pulleys and sensors housed within the device 101. Measurement accuracy may vary depending upon the particular configuration of the system 100, and in general may be capable of measuring distances within a range of about 0.1% to 20% error margin, e.g. 1%, 5%, 10%, 15%, or 20% error margin. In particular, one or more sensors may be configured to detect some feature corresponding to an active length of a tensile element that is wrapped around the pulley(s), where the active length of the tensile element corresponds to the distance D to be measured. Changes to the active length of the tensile element may correspond to changes in the distance D to be measured. The one or more pulleys may be configured to route the tensile element in a desired direction along a desired path, at least a portion of which may correspond to the distance D to be measured. The sensors may detect the active length of the tensile element, and/or changes thereto, either directly or indirectly, which may then be used to calculate a distance measurement.

While some embodiments of the inventive system involve measurement in a vertical direction (i.e., up and down), the system 100 may be capable of obtaining one or more measurements along any axis of interest, e.g., horizontal, non-orthogonal, etc. Furthermore, while the illustrated embodiments involve measurement of the distance D between two rigid plates 103, 105, the system 100 may be capable of obtaining measurements between non-rigid surfaces/components.

It will be appreciated that distance measurement systems as described herein may be capable of accurately taking measurements in wide range, e.g., for any distance D that is less than half of a total length of the tensile element. The distance D to be measured can be varied by varying the total length of the tensile element accordingly. In some embodiments, the system 100 may be configured to take a measurement on a scale of inches. In other embodiments, measurement systems according to the present invention may scale to large applications such as oil rigs, platform pads, cabling placement, and the like.

A. Pulley System

It will be appreciated that the term “pulley” as used herein is broadly defined to include any type of cylindrical element that spins about a central axis and that is capable of having a tensile element wound therearound, including by way of non-limiting example a flanged cylinder, an unflanged cylinder, a drum, a spool, a wheel, a reel, a spindle, a bobbin, a shaft, a spinner, or the like. The tensile element may comprise a cable, wire, string, rope, an elongated plastic element, or the like. Furthermore, while the following discussion assumes that the pulley system only includes one tensile element, pulley systems within the scope of this disclosure may include multiple tensile elements of the same or varying types.

In the illustrated embodiment, a pulley system of the measurement device 101 comprises one or more idler pulleys 205, one or more driver pulleys 207, and one or more spring idler pulleys 208. The pulleys 205, 207, and/or 208 may be attached to the device 101 in a rigid manner. For example, upper pulleys 205a, 205b may be rigidly attached to the upper housing 201 such that they are not capable of movement with respect to the upper housing 201, and lower pulley 205c may be rigidly attached to the lower housing 202 such that the lower pulley 205c is not capable of movement with respect to the lower housing 202. A tensile element, e.g., a wire 206, may be wrapped around one or more of the pulleys such that an active length of the wire 206 corresponds to the distance D to be measured. For example, a length of the wire 206 extending between the upper idler pulleys 205a, 205b and the lower idler pulley 205c may correspond to the separation between the plates 103, 104. Similarly, a change in the length of the wire 206 extending between the upper idler pulleys 205a, 205b and the lower idler pulley 205c may correspond to a change in the separation between the plates 103, 104.

In some embodiments, the idler pulleys 205 may be offset from the plates 103, 104 along the axis of interest 105. For example, a center point of the first idler pulley 205a may be spaced apart from a bottom surface of the plate 103 by an offset distance Da. A center point of the second idler pulley 205b may be spaced apart from the bottom surface of the plate 103 by an offset distance db, which, in some embodiments, is the same as the distance Da. Similarly, a center point of the third idler pulley 205c may be offset from a top surface of the plate 104 by an offset distance Dc. Thus, the length of the wire 206 extending between the idler pulleys 205a, 205b and the idler pulley 205c may be shorter than the distance D to be measured. The computing unit 300, described in detail below, may be configured to account for one or more the offset distances Da, db, Dc when calculating the distance D to be measured.

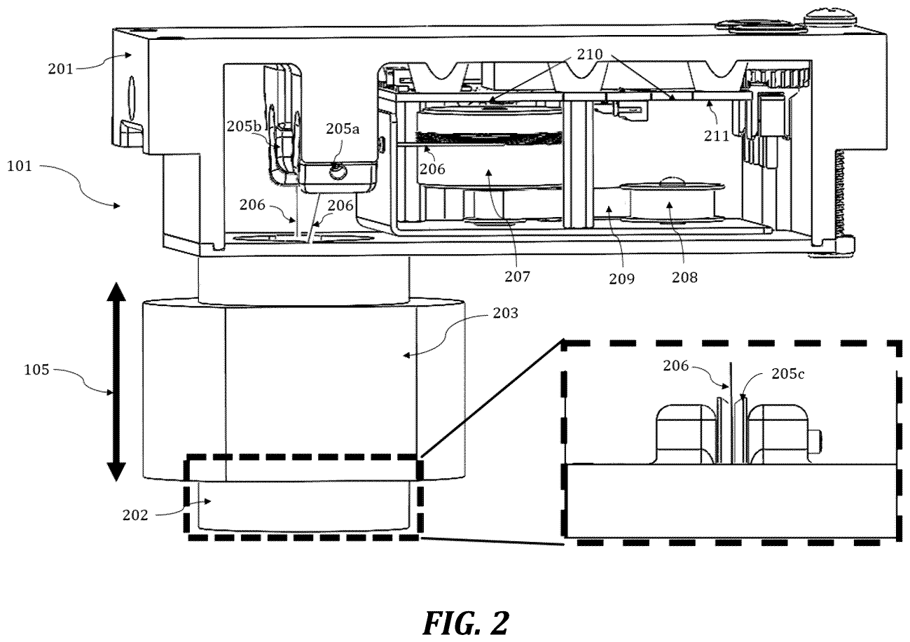

A path followed by the wire 206 may be configured to enable the active length of the wire 206 to change proportionately in response to a change in the distance D along the axis of interest 105. Referring to FIG. 2, the wire 206 may be fixedly connected to the device 101, e.g., to the upper housing 201, at a first end. A second, opposite end of the wire 206 may be wrapped around the driver pulley 207. Between the first and second ends, the wire 206 may follow a path that extends between the upper plate 103 and the lower plate 104. In the illustrated embodiment, the wire 206 extends along the following path: originating at the first end, wrapping around the first idler pulley 205a, wrapping around the third idler pulley 205c, wrapping around the second idler pulley 205a, and finally wrapping around the driver pulley 207.

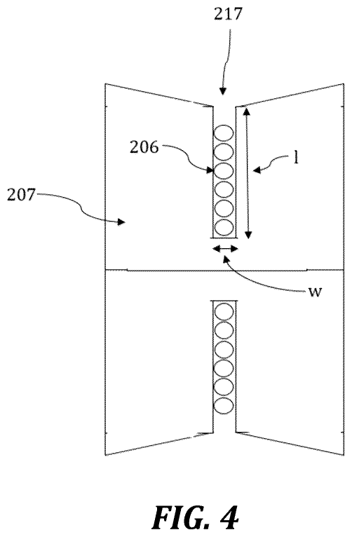

To help ensure measurement accuracy, in some embodiments the path followed by the wire 206 may be configured for consistency. For example, the wire 206 may be wrapped around the pulley(s) in a precise manner to ensure consistency of measurement of the active length of the wire 206 as the wire 206 is wound around and/or released from the pulley(s). As illustrated in FIG. 4, the driver pulley 207 may have a groove 217 formed therein and configured to hold the wire 206 in place in a fixed position when wound around the pulley 207. While only the driver pulley 207 is illustrated, it will be appreciated that any of the plurality of pulleys described herein may be similarly configured. A width w of the groove 217 may correspond to a diameter of the tensile element configured to be wound around the pulley 207; for example, as illustrated, the width w may be only slightly larger than a diameter of the wire 206. In this way, as the wire 206 is wound around the pulley 207, each subsequent layer of the wire 206 is placed directly on top of the previous layer. A length 1 of the groove may correspond to a number of times that the wire 206 is intended to be wrapped around the pulley 207. Thus configured, the groove 217 may eliminate the variability associated with wrapping a tensile element around conventional pulleys.

To further ensure consistency of measurement, the spring idler pulley 208 may operate to ensure a constant tensile force of the wire 206. In particular, the driver pulley 207 may be connected to a spring idler pulley 208 through a spring 209 that is spooled onto the spring idler pulley 209. The spring 209 may be a constant force spring or a variable force spring. Either way, the spring 209 may apply a torque force on the driver pulley 207 which translates to a tension force in the wire 206. Where the spring 209 is a constant force spring, the torque applied and the tension of the wire 206 may similarly be constant, thus ensuring that the wire 206 remains taut throughout the pulley system In this way, when the upper plate 103 moves away from the lower plate 104 along the axis of interest 105, the driver pulley 207 spins to release the wire 206, thereby increasing the active length of the wire 206. When the upper plate 103 moves towards the lower plate 104, the driver pulley 207 spins to wrap the wire 206 therearound, thereby decreasing the active length of the wire 206. Thus, rotation of the driver pulley 207, as well as the spring idler pulley 208 operating on the driver pulley 207, may be closely coupled to changes in the active length of the wire 206. It will be appreciated that the above-described pulley system offers a high tolerance to extreme forces or displacement in any direction, in addition to providing a relatively unrestrained wire 206 that only follows the guides of the wire idler pulleys 205.

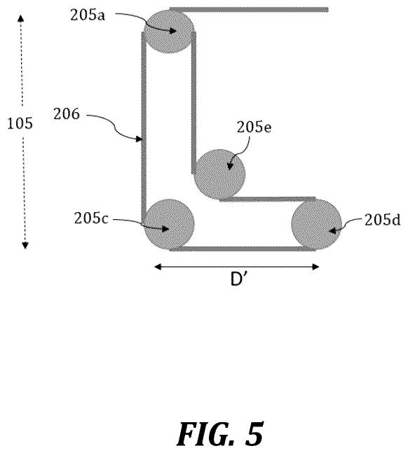

In some embodiments, additional idler pulleys may be arranged within the device 101 to allow for measurement of distances along one or more additional axes. For example, FIG. 5 illustrates an alternative embodiment of a pulley system that involves 4 idler pulleys in a substantially L-shaped configuration. The wire 206 may be wound around and between the four idler pulleys 205a, 205c, 205e, and 205d. In this embodiment, a length of the wire 206 extending between the idler pulleys 205c and 205d may correspond to a distance D′, along an axis transverse to the axis of interest 105. Thus, in this configuration, the pulley system may facilitate the measurement of the first distance D along the first axis of interest 105 and/or the second distance D′ along a second axis of interest.

In some embodiments, the pulley system may be configured for easy assembly and/or disassembly. For example, one or more of the pulleys may have one or more keyed sections to facilitate mounting of the pulley within the housing 201 or 202. In still further embodiments, one or more pulleys may be removably attached to the device 101, to allow for replacement and interchanging of parts due to wear and/or malfunction.

B. Control for Off-Axis Movement

Various features of the device 101 may assist with resisting off-axis movements that might interfere with the measurement of the distance D along the axis of interest 105. Off-axis movements are defined as any movement of the plates 103, 104 in a direction other than along the axis of interest.

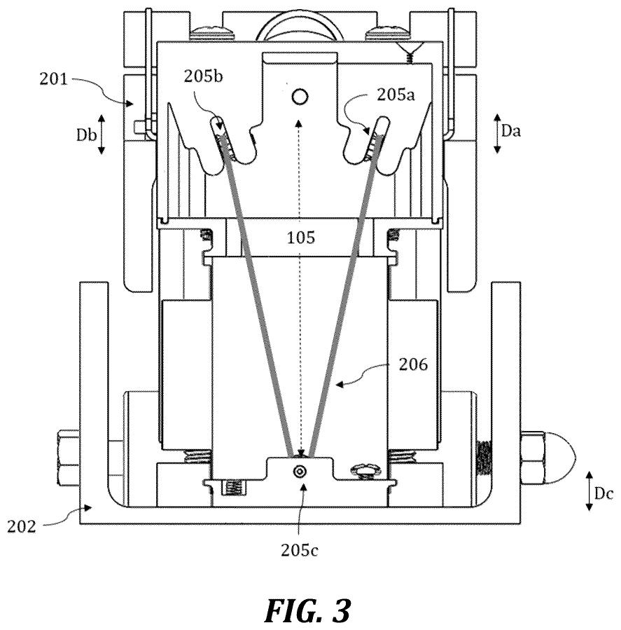

In some embodiments, the path followed by the wire 206 may help the measurement device 101 to resist and/or minimize the impact off-axis movement. For example, in the illustrated embodiment, an orientation of the idler pulleys 205 with respect to one another may cause the device 101 to resists off-axis movement. In particular, as illustrated in FIG. 3, the first idler pulley 205a may be oriented at a first angle with respect to the axis of interest 105. The second idler pulley 205b may be oriented at a second angle with respect to the axis of interest 105, which may, in some embodiments, be the same as the first angle. As described in detail above, the wire 206 may be held taut between the idler pulleys 205a, 205b, and 205c, causing them to mechanically resists shear forces that may be acting on the device 101 and/or the plates 103, 104. Furthermore, because the wire 206 of the illustrated embodiment extends along the axis of interest 105, any movement of the plates 103, 104 in a direction other than the axis of interest 105 will have a smaller impact on the active length of the wire 206 (as compared to a change in the active length had the plates 103,104 moved along the axis of interest 105). Effectively, the path of the wire 206 may minimize movement in off-axis directions. For example, if the plates 103, 104 were to move a distance d in a direction perpendicular to the axis of interest 105, the change in the active length of the wire 206 extending between the first idler pulley 205a and the third idler pulley 205c would be smaller than the distance d.

In addition to minimizing the impact of off-axis movement on the distance measurement, the system 100 may be capable of withstanding off-axis movement without sustaining damage. Conventional measurement devices that are too rigid (e.g., calipers, tape measures, and the like) may snap and/or break under shear forces. By contrast, in the measurement systems described herein, flexible components such as the membrane 203 and the tensile element (e.g., the wire 206) extending between the plates 103, 104 may ensure that the system 100 sustains shear forces without breaking. In particular, the tensile element extending between the plates 103, 104 may have an optimal elastic modulus that is sufficiently elastic to sustain off-axis movement without breaking but also sufficiently rigid to prevent stretching that could impact the distance measurement. An example of such materials may include, without limitation, various metals, plastics, textiles, and combinations thereof. In some embodiments, the tensile element may be subject to one or more “wear” cycles prior to assembly within the device 101 to ensure an optimal elastic modulus.

In general, pulley systems as described herein may be capable of capturing an accurate measurement of the distance D when the plates 103, 104 are able to move generally perpendicularly to the axis of interest by as much as 20% of the axial movement amount.

C. Mechanical Amplification

The device 101 may be configured to enhance the accuracy of measurement via amplification of a signal representing the distance D. For example, in some embodiments, a path defined by the wire 206 may be configured to provide a source of mechanical amplification, e.g., by causing the wire 206 to traverse the distance D more than once. In particular, in the illustrated embodiment, the wire 206 traverses the distance D twice: a first time as the wire 206 extends between the first idler pulley 205a and the third idler pulley 205c, and a second time as the wire 206 extends between the second idler pulley 205b and the third idler pulley 205c. It will be appreciated that mechanical amplification may be achieved by various mechanisms, including but not limited to: increasing the number of times that the wire 206 is wrapped around the idler pulleys 205, increasing a number of idler pulleys 205, increasing a distance between idler pulleys 205, and the like. Thus, the path of the wire 206 may be configured such that a length of the active wire 206 increases by some multiple (e.g., in a range of between about 1.5× and 5×) of the actual distance to be measured.

D. Sensors

Changes to the pulley system that correspond to a change in the distance to be measured D may be detected by a variety of sensors. In particular, the sensors may detect rotation of one or more pulleys within the pulley system that corresponds to a change in the active length of the wire 206. The term “sensor” as used herein is broadly defined to include any suitable device for detecting rotation of one or more pulleys within the pulley system, including by way of non-limiting example a magnetic encoder, an optical encoder, a rotary potentiometer, or the like.

In the illustrated embodiment, one or more rotary sensors are used to detect rotation of one or more pulleys as the wire 206 is released and/or retracted. For example, one or more magnetic encoders 210 may be mounted on a printed circuit board 211 directly over the driving pulley 207 and/or the spring idler pulley 208 to electronically measure the rotation of a magnets adhered to the top of the driving pulley 207 and/or the spring idler pulley 208. A first magnet may be adhered to the top of the pulley 207 and/or a second magnet may be adhered to the top of the pulley 208, such that the first and second magnets rotate at the same rate as the pulleys 207, 208, respectively. The driver pulley 207 may have a sufficiently different diameter than the spring idler pulley 208 to ensure that the magnetic encoder 210 can distinguish between rotation of each pulley.

The sensors of the device 101 may be powered by the battery pack 102. In some embodiments, the sensors are configured to operate under power constraints. In particular, the device 101 may be configured such that constant detection of rotation is not required. For example, as explained above, the device 101 may utilize multiple magnetic sensors 210 to capture a position of multiple pulleys having a known gearing ratio, as opposed to utilizing a single magnetic sensor to monitor a single pulley constantly.

In some embodiments, a radius of the driving and/or idler pulleys may vary to achieve a gearing ratio that expands the effective movement of a magnet attached thereto beyond 360 degrees without constant monitoring. In particular, where a diameter of the driver pulley 207 is different from a diameter of the spring idler pulley 208, the computing unit 300 (described in detail below) may be able to infer the number and/or amount of rotation that each pulley 207, 208 has undergone based a position of each pulley 207, 207 and on the gearing ratio.

In some embodiments, multiple driving pulleys 207 and multiple spring idler pulleys 208 may be wound and applied with separate magnets on each. In still further embodiments, multiple rotary sensors may be used to create redundancy.

In some embodiments, the device 101 includes additional sensors disposed within the housings 201, 202 to monitor environmental conditions therein. By way of non-limiting example, the housings 201, 202 may contain one or temperature sensors, accelerometers, one or more humidity sensors, and the like.

E. Computing Unit

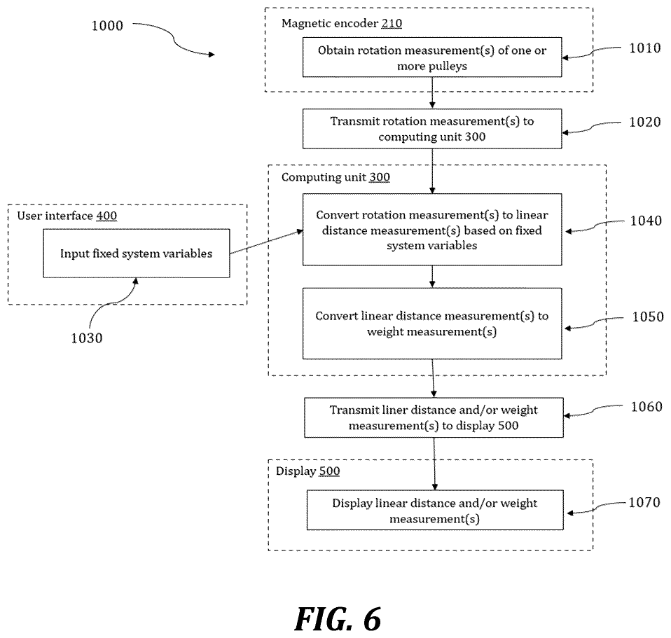

In some embodiments, a computing unit 300 may be in operative communication with various sensors and/or components of the device 101 for producing and/or communicating the final measurement output of the system 100. As illustrated in FIG. 6, the computing unit 300 may be configured to convert rotation values of the rotary sensor(s) 210 into a linear displacement measurement. The computing unit 300 may calculate one or more linear displacement measurements (e.g., the distance D between the plates 103, 104) based upon the rotation values derived from the rotary sensor(s) 210 along with various fixed inputs, e.g., an initial known reference distance along the axis of measurement 105, a number of times that the wire 206 is wrapped around any of the pulleys, a diameter of the driving pulley 207, and/or a diameter of the spring idler pulley 208. In some embodiments, the computing unit 300 may be configured to adjust for a fixed displacement of the idler pulleys 205 from the surfaces between which the distance D is to be measured. For example, offset distances Da, db, Dc of the idler pulleys 205a, 205b, 205b may be input at fixed variables to the computing unit 300. When converting rotational measurements to the linear distance measurement D, the computing unit 300 may be configured to account for one or more of the offset distances Da, db, Dc.

Similarly, the computing unit 300 may be housed locally on the device 101, and/or may be a remote computing unit in communication with the device 101. In some embodiments, the computing unit 300 may communicate with the sensors and/or components via wireless and/or wired connections. By way of non-limiting example, the wireless connections may include Bluetooth, near field communications, cellular, or other similar wireless communication systems. In some embodiments, the computing unit 300 receives sensor data (e.g., magnetic displacement) from the sensors and components via a wired connection (or mix of wired or wireless communication mechanisms).

The fixed inputs may be input by an end user of the system 100 via a user interface 400. The user interface 400 may be part of the system 100, e.g., an interactive display affixed to the device 101. In other embodiments, the user interface 400 may be a remote device in operative communication with the system 100, e.g., a mobile computing device, a computer, etc. Like the computing unit 300, the user interface 400 may be in operative communication with the computing unit 300 via a wired, wireless, or combination of wired and wireless communication mechanisms. The user interface 400 may be used by a user who accesses an interface (e.g., a dashboard interface) for work and/or personal activities. The user interface 400 may be associated with one or more devices for presenting visual media, such as a display, including a monitor, a television, a projector, and/or the like. The user interface 400 renders user interface elements and receives input via user interface elements. Examples of interfaces include a graphical user interface (GUI), a command line interface (CLI), a haptic interface, and a voice command interface. Examples of user interface elements include checkboxes, radio buttons, menus, dropdown lists, list boxes, buttons, toggles, text fields, date and time selectors, command lines, sliders, pages, and forms.

Once the computing unit 300 has calculated the linear distance measurement(s), the computing unit 300 may be configured to transmit these measurements to a user display 500 for viewing by the end user. In some embodiments, the display 500 may be the same and/or part of the user interface 400 used to input the fixed variables. In other embodiments, the distance measurement is transmitted to a separate display 500. Similar to the computing unit 300, the display 500 may be housed locally on the device 101, and/or may be in remote communication with the device 101 by a wired, wireless, or combination of wired and wireless connection mechanisms. The display 500 may be any device which converts electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal). In some embodiments, the linear distance measurement(s) may be communicated to the user via an electronic communication (e.g., email, SMS, etc.) transmitted to a user, or any other means of conveying the actions to the user (e.g., via an audio output announcing the distance measurement(s) to the user).

It will be appreciated that the computing unit 300 may be configured to receive and transmit additional relevant data, e.g., a time of measurement, readings from various devices and environmental sensors (e.g., temperature sensors, humidity sensors, accelerometers, and the like), a unique identifier for each measurement, data regarding the equipment/apparatus to which the device 101 is attached, battery life status, and the like.

Consistent with embodiments of the present disclosure, the computing unit 300 may be configured to calculate a weight based on the distance measured by the system 100. Conversion of a linear distance measurement into a weight measurement is covered by PCT number WO2021/231,940 which is hereby incorporated by reference herein in its entirety.

### Apparatus Use

Embodiments of the present disclosure provide a system operative by a set of methods comprising instructions configured to operate the aforementioned components in accordance with the methods. The following depicts an example of a method of a plurality of methods that may be performed by at least one of the aforementioned components. Various hardware components may be used at the various stages of operations disclosed with reference to each component.

For example, although methods may be described to be performed by a single component, it should be understood that, in some embodiments, different operations may be performed by different components in operative relation with one another. For example, an apparatus may be employed in the performance of some or all of the stages disclosed with regard to the methods. As such, the apparatus may comprise at least one architectural component disclosed herein.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

Consistent with embodiments of the present disclosure, a method may be performed by at least one of the aforementioned components. The method may be embodied as, for example, but not limited to, computer instructions, which when executed, perform the method.

An exemplary method 1000 for obtaining linear distance measurement(s) between two objects and/or surfaces of the objects is illustrated in FIG. 6. A first step 1010 of the method 1000 may involve obtaining one or more rotation measurements of one or more pulleys within the pulley system of the device 101. In particular, this step may involve the magnetic encoder(s) 210 obtaining rotation measurements of the driving pulley 207 and/or the spring idler pulley 208. The rotation measurement(s) may then be transmitted to the computing unit 300 (step 1020), via wireless, wired, or a combination of wireless and wired communication mechanisms. Either before or after the rotation detection step 1010, an input step 1030 may occur which involves an end user inputting various fixed system variables via a user interface 400. The fixed system variables may include, as described above, an initial reference distance along the axis of interest, diameters of one or more pulleys in the pulley system, and the like.

Upon receipt of the rotation measurement(s) and/or the fixed system variables, the computing unit 300 may proceed to convert the rotation measurement(s) to linear distance measurement(s) based on the fixed system variables (step 1040). Optionally, the computing unit 300 (and/or additional computing units) may convert the linear distance measurements(s) into weight measurements according to the teachings of PCT number WO2021/231,940. At step 1060, the computing unit 300 may transmit the linear distance and or weight measurement(s) to the display 500 for viewing by an end user, which may be the same or a different end user than the end user who input the fixed system variables at step 1030. Finally, the display 500 may display the distance and/or weight measurement(s) at step 1070.

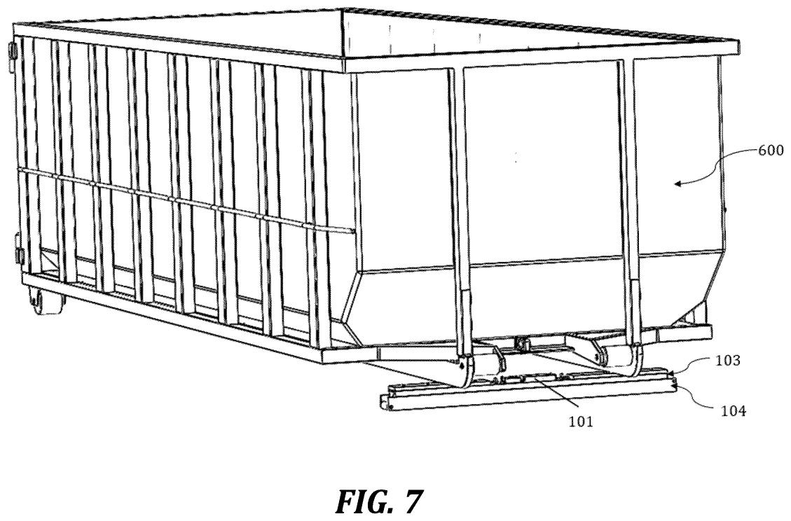

FIG. 7 illustrates an example use case of the device 101, in combination with a distance-to-weight measurement conversion system, to determine the weight of a container 600, e.g., a waste container, a transport container for a train car, or the like. In the illustrated embodiment, the device 101 may be used to measure the linear distance between the top plate 103 and bottom plate 104, which may be converted into a weight measurement of the container 600. The container 600 may be frequently pushed against when being loaded causing a shear force to occur between top plate 103 and bottom plate 104. As described above, the device 101 may be configured to resist the off-axis loading caused by such shear forces, such that the shear forces do not influence the final linear distance measurement.

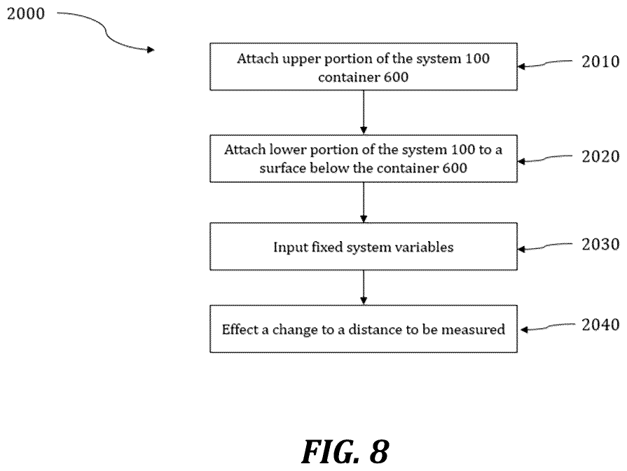

FIG. 8 illustrates an example method 2000 of using the system 100 according to the use case of FIG. 7. A first step of the method 2000 may involve attaching the system 100 to the container 600. In particular, the top plate 103 of may be rigidly attached to a bottom edge of the container 600, via any suitable means that prevents relative movement of the upper housing 201 with respect to the container 600 (step 2010). In other embodiments, the upper housing 201 of the measurement device 101 may be directly attached to the container 600. Optionally, a second step (step 2020) may involve attaching the bottom plate 104 to a static surface spaced at a fixed distance below the bottom of the container 600. Similar to step 2010, step 2020 may instead involve attaching the bottom housing 202 directly to the static surface. A third step 2030 may involve inputting fixed system variables into the system 100 to enable calculation of a distance and/or weight measurement by the computing unit 300. A final step 2040 may involve effecting a change to the distance to be measured D, for example by loading the container 600 with trash or other items that cause the top plate 103 to compress against the bottom plate 104.

Although the stages are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

What is claimed is:

1. A distance measurement device, comprising:
an upper housing rigidly affixed to a first surface;
a lower housing rigidly affixed to a second surface, the second surface being spaced apart from the first surface by a distance to be measured along an axis of interest;
a flexible membrane movably connecting the upper housing to the lower housing;
a pulley system disposed within the upper and lower housings and having a tensile element passing therethrough, the pulley system being configured to adjust an active length of the tensile element corresponding to the distance to be measured while minimizing the impact of any movement of the first and second surfaces along a direction other than the axis of interest; and
one or more sensors that detect rotation of one or more pulleys within the pulley system, wherein the rotation corresponds to a change in the active length of the tensile element.

2. The distance measurement device of claim 1, wherein the pulley system comprises first and second idler pulleys disposed within the upper housing and a third idler pulley disposed within the lower housing.

3. The distance measurement device of claim 1, wherein the pulley system comprises at least four idler pulleys.

4. The distance measurement device of claim 3, wherein the device is configured to measure an additional distance along an axis that is different from the axis of interest.

5. The distance measurement device of claim 1, wherein the pulley system is configured to maintain the tensile element taut, such that the tensile element is effective to resist movement of the first and second surfaces along a direction other than the axis of interest.

6. The distance measurement device of claim 2, wherein the pulley system further comprises a driver pulley around which a first end of the tensile element is wound and a spring idler pulley having a spring that acts on the driver pulley to ensure that the tensile element remains taut throughout the pulley system.

7. The distance measurement device of claim 6, wherein the spring is a constant force spring.

8. The distance measurement device of claim 6, wherein rotation of the driver pulley and the spring idler pulley corresponds to a change in the active length of the tensile element.

9. The distance measurement device of claim 6, wherein a first magnet is attached to the driver pulley and a second magnet is attached to the spring idler pulley and the one or more sensors are configured to detect rotation of the driver pulley and the spring idler pulley, respectively, based on movement of the first and second magnets.

10. The device of claim 9, wherein the driver pulley has a different diameter than the spring idler pulley.

11. The distance measurement device of claim 1, wherein the pulley system mechanically amplifies the active length of the tensile element to increase an accuracy of the distance measurement.

12. The distance measurement device of claim 11, wherein the mechanical amplification of the active length of the tensile element is equivalent to twice the distance to be measured.

13. The distance measurement device of claim 1, further comprising a computing unit that converts one or more rotation measurements of the one or more sensors into a linear distance measurement corresponding to the distance to be measured.

14. The distance measurement device of claim 13, wherein the computing unit converts the linear distance measurement into a weight measurement.

15. The distance measurement device of claim 1, further comprising at least one of a temperature sensor or a humidity sensor.

16. A method of measuring a distance, comprising:
attaching an upper housing to a first surface, wherein the first surface is rigidly connected to a container;
attaching a lower housing to a second surface;
effecting a change in a distance between the first and second surfaces; and
causing a pulley system disposed within the upper and lower housings to displace an active length of a tensile element that corresponds to the change in the distance between the first and second surfaces along an axis of interest.

17. The method of claim 16, wherein effecting the change in the distance comprises placing items the container.

18. The method of claim 17, further comprising measuring a weight of the items that are placed in the container based on a distance measurement of the distance between the first and second surfaces.

19. The method of claim 16, further comprising inputting fixed system variables to assist with a calculation of the distance between the first and second surfaces.

20. The method of claim 16, wherein the pulley system is configured to adjust the active length of the tensile element corresponding to the distance between the first and second surfaces while resisting any movement of the first and second surfaces along a direction other than the axis of interest.

21. The method of claim 16, wherein the pulley system comprises first and second idler pulleys disposed within the upper housing and a third idler pulley disposed within the lower housing.

22. The method of claim 16, wherein the pulley system comprises at least four idler pulleys.

23. The method of claim 16, further comprising measuring an additional distance along an axis that is different from the axis of interest.

24. The method of claim 16, wherein the pulley system is configured to maintain the tensile element taut, such that the tensile element is effective to resist movement of the first and second surfaces along a direction other than the axis of interest.

25. The method of claim 21, wherein the pulley system further comprises a driver pulley around which a first end of the tensile element is wound and a spring idler pulley having a spring that acts on the driver pulley to ensure that the tensile element remains taut throughout the pulley system.

26. The method of claim 25, wherein the spring is a constant force spring.

27. The method of claim 25, wherein rotation of the driver pulley and the spring idler pulley corresponds to a change in the active length of the tensile element.

28. The method of claim 25, wherein a first magnet is attached to the driver pulley and a second magnet is attached to the spring idler pulley and the one or more sensors are configured to detect rotation of the driver pulley and the spring idler pulley, respectively, based on movement of the first and second magnets.

29. The device of claim 28, wherein the driver pulley has a different diameter than the spring idler pulley.

30. The method of claim 16, wherein the pulley system mechanically amplifies the active length of the tensile element to increase an accuracy of the distance measurement.

31. The method of claim 30, wherein the mechanical amplification of the active length of the tensile element is equivalent to twice the distance to be measured.
